(19) United States
(12) Patent Application Publication
(10) Pub. No.: US 2002/0108583 A1
(43) Pub. Date: Aug. 15, 2002

(54) Living organism observation tool

(75) Inventor: Akira Nagahashi, Osaka (JP)

Correspondence Address: RADER FISHMAN & GRAUER PLLC, LION BUILDING, 1233 20TH STREET N.W., SUITE 501, WASHINGTON, DC, 20036, US

(73) Assignee: SEIBUNSYA CO., LTD.

(21) Appl. No.: 09/781,211

(22) Filed: Feb. 13, 2001

(51) Int. Cl. A01K 63/00

(52) U.S. Cl. 119/245

(57) ABSTRACT

A living organism observation tool is to be used for observation of small animals (e.g. insects, little fish) or plants. This tool comprises a pair of frames which can be folded over each other, with each frame being tightly attached to the other along a periphery thereof, and an elastic transparent sheet which is spread over each frame in such a manner as tightly attached to the periphery of the frame. When the frames are folded over each other, with a sheeted surface of each frame facing that of the other frame, the sheets are tightly attached together, so that an organism is sandwiched between the sheets and observed in this state.

### BACKGROUND OF THE INVENTION

The present invention relates to a living organism observation tool to be used for observation of small living organisms (e.g. insects, little fish), microorganisms (e.g. plankton) and plants.

In general, a small living organism such as an insect is collected with a catching net. After picked out of the catching net, the insect is observed in the hand or in an insect cage. In some cases, an insect or the like is pinned up and examined in a fixed state.

For observation of a small underwater creature like a little fish, an observation object is scooped up from a river or a pond, and kept in an aquarium or laid on a piece of paper, etc. Microorganisms like plankton are usually placed on a preparation and examined with the naked eye or with the use of a microscope or a magnifying glass.

As to plants including grass and flowers, it is common to pick up wild plants growing in the field and examine them in the hand.

### SUMMARY OF THE INVENTION

A living organism observation tool according to claim 1 of the present invention is to be used for observation of a living organism including an insect, a little fish and other small animals or a plant. This tool comprises a pair of frames which can be folded over each other, with each frame being tightly attached to the other along a periphery thereof, and an elastic transparent sheet which is spread over each of the frames in such a manner as tightly attached along the periphery of each frame. When the frames are folded over each other, with a sheeted surface of each frame facing that of the other frame, the sheets are tightly attached together, so that an organism can be sandwiched between the sheets and observed in this state.

A living organism observation tool according to claim 4 of the present invention is to be used for observation of a living organism including an insect, a little fish and other small animals or a plant. This tool comprises a pair of frames, one of which can fit into the other, and an elastic transparent sheet which is spread over each of the frames in such a manner as tightly attached along a periphery of each frame. When the frames are fitted together, with a sheeted surface of each sheet facing in the same direction, the sheets are tightly attached together, so that an organism can be sandwiched between the sheets and observed in this state.

In the arrangements according to claim 1 and claim 4, a net or a transparent plate may be disposed over one of the pair of frames in such a manner as tightly attached along the periphery of the frame.

### BRIEF DESCRIPTION OF THE DRAWINGS

FIG. 1 is a plan view showing an embodiment of the present invention, with the frames being open.

FIG. 2 is a sectional view taken along the line X-X of FIG. 1.

FIG. 3 is a partially enlarged view of FIG. 2, showing an area where a sheet is attached.

FIG. 4 is a plan view showing the structure of a receiver frame applicable to the embodiments of the present invention.

FIG. 5 is a sectional view showing the structure of a receiver frame applicable to the embodiments of the present invention.

FIG. 6 is a bottom view showing the structure of a fixture frame applicable to the embodiments of the present invention.

FIG. 7 is a sectional view showing the structure of a fixture frame applicable to the embodiments of the present invention.

FIG. 8 is a plan view showing the structure of an outer frame as used in the embodiments of the present invention.

FIG. 9 is a perspective view showing the structure of a grip provided on the outer frame shown in FIG. 8.

FIG. 10 is a view showing the use of the grip.

FIG. 11 is a plan view showing another embodiment of the present invention.

FIG. 12 is a front view showing yet another embodiment of the present invention.

FIGS. 13(a) and (b) show the structures of a different embodiment of the present invention, with the frames being open (FIG. 13(a)) and with the frames being folded together (FIG. 13(b)).

FIGS. 14(a) and (b) show the structures of a further different embodiment of the present invention, in which FIG. 14(b) illustrates the state where the frames are fitted with each other.

### DETAILED DESCRIPTION OF THE INVENTION

The embodiments of the present invention are hereinafter described with reference to the drawings.

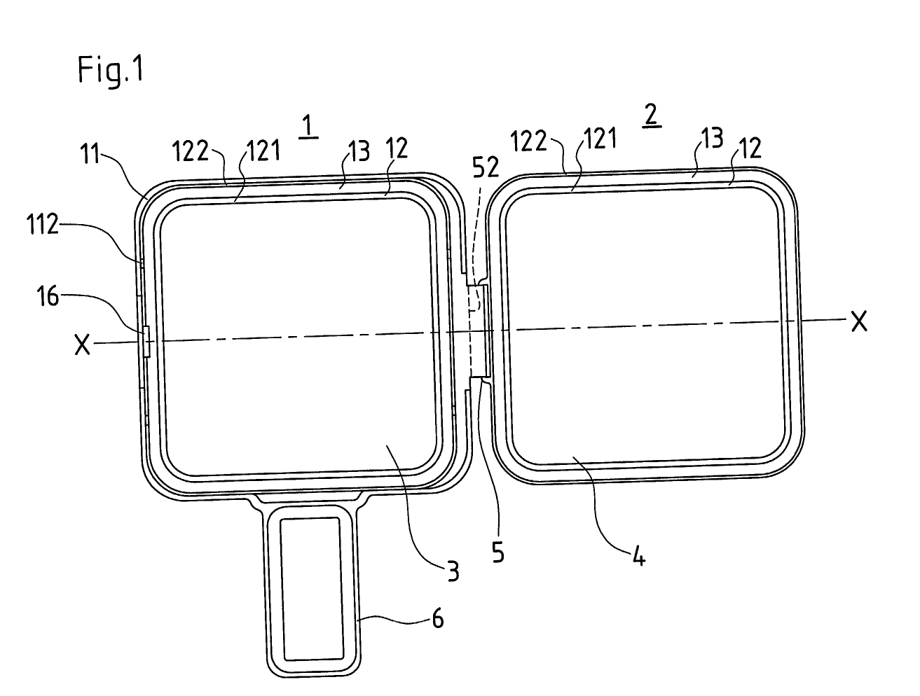

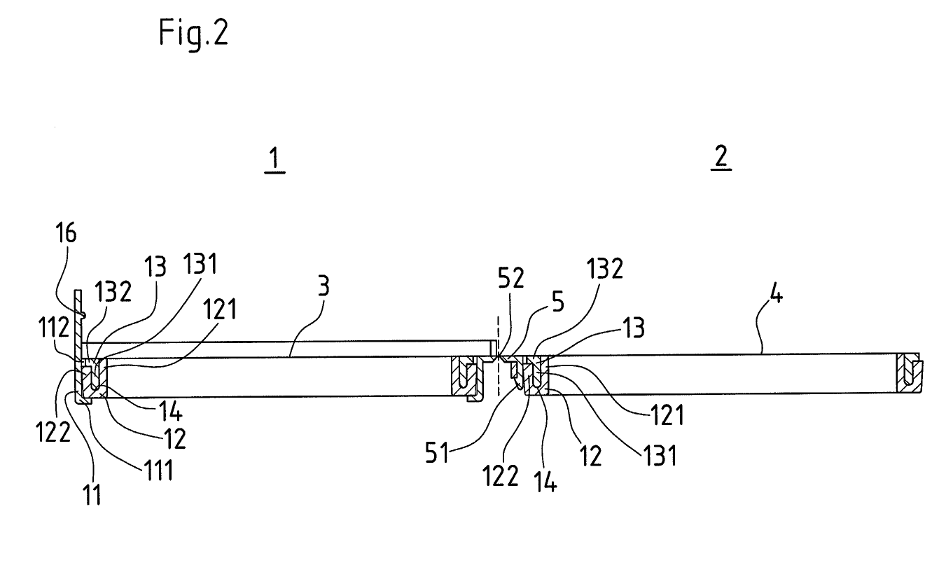

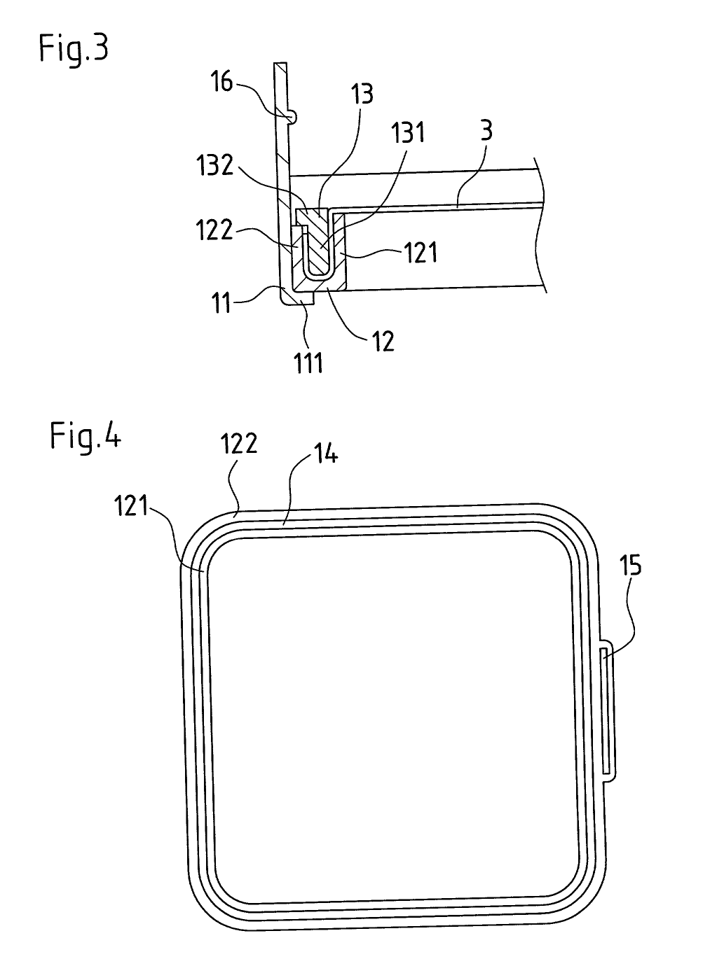

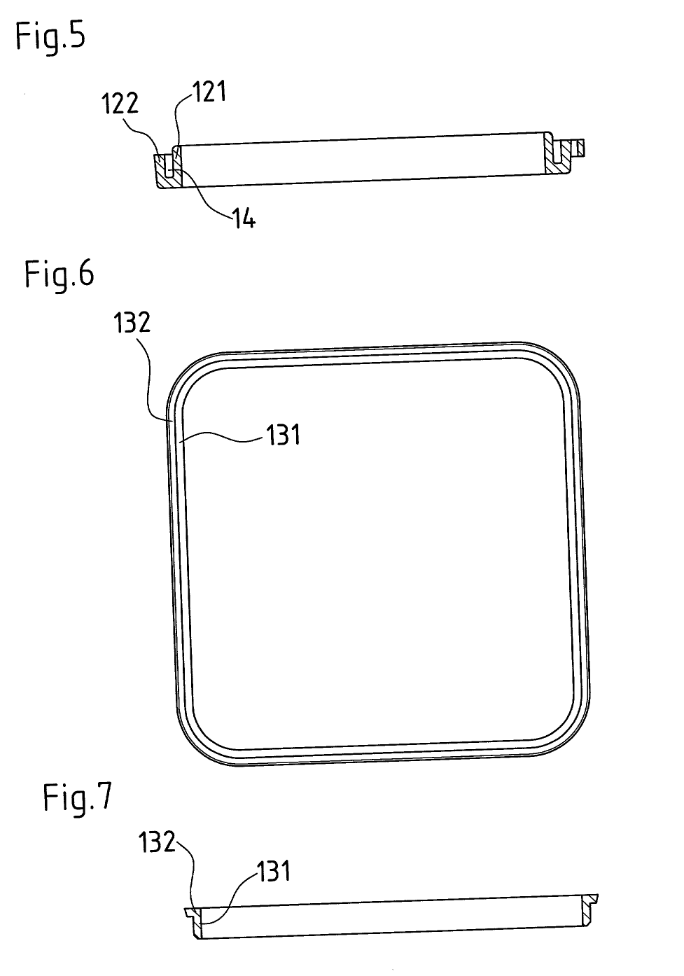

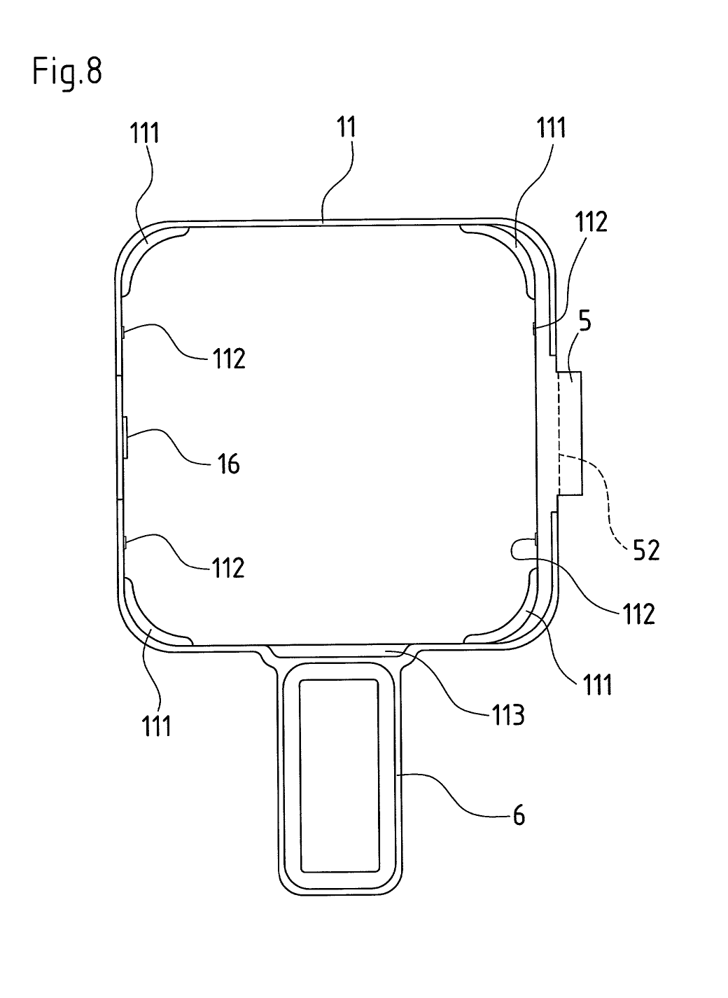

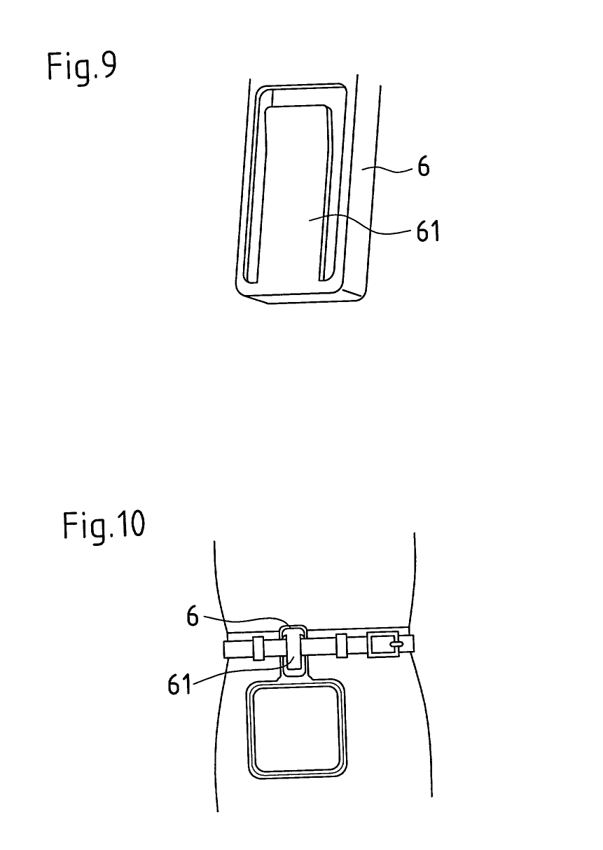

FIG. 1 is a plan view showing an embodiment of the present invention, with the frames being open. FIG. 2 is a sectional view thereof. FIG. 3 is a partially enlarged view of FIG. 2 showing an area where a sheet is attached. FIG. 4 is a plan view showing the structure of a receiver frame applicable to this embodiment, and FIG. 5 is a sectional view thereof. FIG. 6 is a bottom view showing the structure of a fixture frame applicable to this embodiment, and FIG. 7 is a sectional view thereof. FIG. 8 is a plan view showing the structure of an outer frame applicable to this embodiment, and FIG. 9 is a perspective view of a grip provided on the outer frame.

A living organism observation tool of this embodiment comprises a pair of frames (i.e. a grip frame 1, a cover frame 2) and sheets 3, 4 laid over the grip frame 1 and the cover frame 2, respectively. The grip frame 1 comprises an outer frame 11, a receiver frame 12 and a fixture frame 13. The cover frame 2 comprises another receiver frame 12 and another fixture frame 13. The receiver frames 12 and the fixture frames 13 are common to the grip frame 1 and the cover frame 2. These frames are made of plastic into a near-square frame-shaped structure. Owing to this structure, the direction of the frames can be arranged with a certain degree of freedom, and it is easy to use such frames. In addition, these frames should have a sufficient strength so as not to yield to external forces. Four corners of each frame are chamfered to prevent an injury to an observer.

In the receiver frame 12, a fitting groove 14 is formed in the middle of its top surface along the entire peripheral wall. As illustrated in FIG. 3, the fitting groove 14 has an interior wall 121 and an external wall 122 which is slightly lower than the interior wall 121. The sheet 3 is spread across one of the open surfaces of the receiver frame 12, with its periphery buried into the fitting groove 14. Along one side of the external wall 122, there is formed an engagement slot 15 for engaging with a hinge 5 to be mentioned below (The engagement slot 15 is utilized only in the cover frame 2, and has no function in the grip frame 1.).

The fixture frame 13 serves to press down the sheet 3 so that the sheet 3 can be spread over the receiver frame 12. The fixture frame 13 comprises a fitting piece 131 to be inserted into the fitting groove 14, and a flange 132 formed externally and entirely along the top peripheral edge of the fitting piece 131. The flange 132 increases the overall strength of the fixture frame 13 and ensures securer attachment of the sheet 3. When the fitting piece 131 is fitted into the fitting groove 14, the total height of the flange 132 and the exterior wall 122 of the fitting groove 14 in the receiver frame 12 should be equal to the height of the interior wall 121 of the fitting groove 14.

The sheets 3, 4 are laid over the receiver frames 12 and the fixture frames 13 for the grip frame 1 and the cover frame 2, respectively. The frames are folded over each other in this condition.

The sheets 3, 4 are transparent sheets which, as mentioned above, are spread over the receiver frames 12 of the grip frame 1 and the cover frame 2, respectively. The sheets 3, 4 have rich stretchability and high strength, so that they do not tear even on contact with a sharp projection. For such sheets, polyurethane is the most desirable material, but polyethylene may be used as well. Generally, urethane- or butadiene-containing materials are suitable. The sheets 3, 4 are the same components and spread over the surfaces at which the grip frame 1 and the cover frame 2 come into contact with each other. In this embodiment, referring to FIG. 3, the outer periphery of the sheet 3 (4) is tucked in between the receiver frame 12 and the fixture frame 13. When the fitting piece 131 of the fixture frame 13, together with the sheet 3 (4), is inserted into the fitting groove 14 in the receiver frame 12, the sheet 3 (4) is tightly attached on and spread over the receiver frame 12.

The process for spreading the sheets 3, 4 over the receiver frames 12 should not be limited to the above-described manner. By way of example, without using the fixture frame 13, the sheet 3 (4) can be directly attached to the receiver frame 12 by ultrasonic welding. In the ultrasonic welding process, the receiver frame 12 does not need the fitting groove 14. As another step, the fixture frame 13 may be replaced with a flexible wire such as a silkworm gut or a nylon string, in which case the sheet 3 (4) is positioned over the receiver frame 12 and forced down into the fitting groove 14 with the wire. When such wire is utilized, it is recommended that the fitting groove 14 in the receiver frame 12 should have the internal wall 121 and the external wall 122 of the same height. In addition, an adhesive (e.g. chemical glue, double-face adhesive tape) may be employed to adhere the sheet 3 (4) to the receiver frame 12 in a stretched manner.

The receiver frame 12 spread with the sheet 3 is fitted into the outer frame 11, which surrounds the outer periphery of the receiver frame 12. As shown in FIG. 8, a hinge 5 for linking the grip frame 1 with the cover frame 2, and a grip 6 project outwardly from the outer frame 11. Inside the outer frame 11, an indent 113 is provided on the side formed with the grip 6. In the grip frame 1, the indent 113 receives the portion of the engagement slot 15 formed in the receiver frame 12. The hinge 5 has an engagement piece 51 which vertically protrudes from the tip end. By inserting the engagement piece 51 into the engagement slot 15 formed in the receiver frame 12 of the cover frame 2, the outer frame 11 of the grip frame 1 is linked with the receiver frame 12 of the cover frame 2. The hinge 5 further includes a bending portion 52 which locates longitudinally in the middle of the hinge 5. Free bending movement at the bending portion 52 enables the grip frame 1 and the cover frame 2 to be folded over each other.

At four inside corners of the outer frame 11, holders 111 for supporting the bottom of the receiver frame 12 are provided along the bottom edge. On the corresponding positions along the top edge, projections 112 are disposed for checking the top of the receiver frame 12 and fixing the receiver frame 12 within the outer frame 11. Besides, opposite to the hinge 5, the outer frame 11 is internally equipped with a stopper 16 for securing the cover frame 2 on the grip frame 1.

In the present invention, the grip 6 is an optional, but not essential, element. Where the grip 6 is employed, the grip 6 may be provided at a suitable position on any optional side of the outer frame 11, except the side to be linked with the cover frame 2. Alternatively, the grip 6 may be formed on each of the grip frame 1 and the cover frame 2. In this case, when the grip frame 1 and the cover frame 2 are folded over each other, the grips are joined as well. In addition, as illustrated in FIG. 9, the grip 6 may be combined with a plate-shaped clip 61, which makes the living organism observation tool of the present invention portable. By means of the clip 61, the tool can be fastened on the clothes, belt, etc., as shown in FIG. 10.

The living organism observation tool of the above structure is utilized in the following manner.

To begin with, while the grip frame 1 and the cover frame 2 are open, an insect or other organism to be observed (hereinafter also mentioned as “observation object” or “object”) is placed on the sheet 3. Then, the grip frame 1 and the cover frame 2 are folded together in a quick motion (closed condition). In this closed condition, the sheets 3, 4 stretch in correspondence with the profile of the organism, whereas they are tightly attached to each other around the organism. Thus covered between the highly strechable sheets 3, 4, the organism is held stationary or, in the case of animals, held in the state of limited movement (i.e. capable of moving its feet, etc. to some degree). Under this condition, a person can freely observe the organism from both sides of the transparent sheets 3, 4.

As modifications of the above embodiment, the sheet spread over either of the grip frame 1 or the cover frame 2 may be replaced with a net or a transparent plate.

Firstly, description is directed to the use of a net. For the purpose of explanation, a net is to be laid over the grip frame 1.

According to this modification, a net is spread over the grip frame 1, instead of the sheet 3. The meshes of the net should be fine enough to catch a small organism living in the water (e.g. little fish) or microorganisms like plankton. The net can be spread in the same manner as for the sheet 3. In the meantime, the cover frame 2 is provided with the sheet 4 as in the above embodiment. Since the other structures are also similar to the above embodiment, no further details are repeated here. In this embodiment, however, the outer frame 11 should be designed a little higher to form a surrounding wall around the net. This structure prevents a little fish or like organism from escaping.

For this modified embodiment, the net may be laid over the receiver frame 12 of the grip frame 1 from which the sheet 3 has been removed. Instead, a replacement frame may be separately prepared by equipping a net across a frame equivalent to the receiver frame 12, and exchanged with the receiver frame 12 laid with the sheet 3.

In using the living organism observation tool of this modified structure, when a little fish, etc. in the water is scooped up with the net, the cover frame 2 is quickly folded over the net frame (closed condition). In this closed condition, the little fish, etc. is sandwiched between the net and the sheet 4. Thus, a person can observe the fish, etc. through the transparent sheet 4.

In the following description, a transparent plate is utilized as the replacement of the sheet.

In this modification, a transparent plate is equipped over either of the grip frame 1 or the cover frame 2.

The transparent plate is a thin plate made of glass, plastic, etc. The transparent plate may be attached directly to, or integrated with, the grip frame 1 or the cover frame 2.

The transparent plate may be molded in a meshed form. With a meshed transparent plate, underwater organisms (e.g. little fish) or microorganisms like plankton can be scooped up for observation.

Additionally, the transparent plate may include one or more through-holes which are located, for example, at the four corners. The size of each through-hole is small enough to keep an organism in and large enough to discharge air or water.

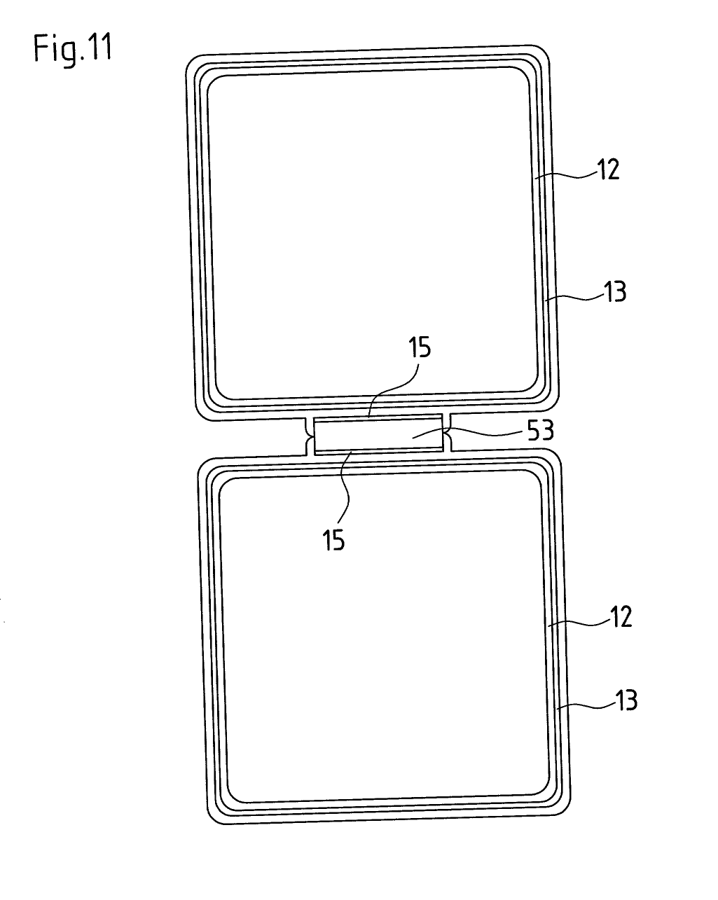

FIG. 11 is a plan view of the second embodiment.

The second embodiment does not employ the outer frame 11 as used in the first embodiment illustrated in FIG. 1 to FIG. 8. In this embodiment, a pair of frames comprise a pair of receiver frames 12, 12 and fixture frames 13, 13. The engagement slots 15, 15 in the pair of receiver frames 12, 12 are abutted against each other. The receiver frames 12, 12 are made foldable by connecting the engagement slots 15, 15 with a suitable hinge element 53.

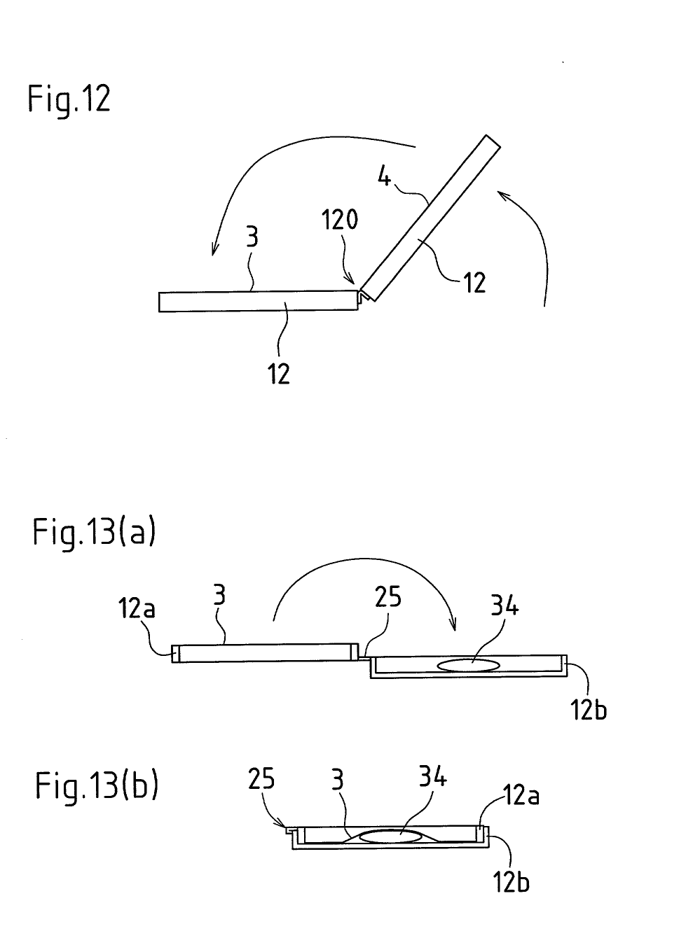

FIG. 12 shows the third embodiment.

Similar to the second embodiment shown in FIG. 11, the third embodiment does not use the outer frame 11. Instead, a pair of receiver frames 12, 12 are integrally molded in such a manner that they share one of their side edges (i.e. the frames are joined at a connection 120). The receiver frames 12, 12 are foldable at the connection 120.

Similar to the first embodiment, the embodiments shown in FIG. 11 and FIG. 12 may be modified to place a net or a transparent plate over one of the frames, instead of the sheet.

FIG. 13 shows the fourth embodiment.

With regard to the case where the receiver frames 12, 12 are foldable in the manner shown in FIG. 11, the fourth embodiment interposes a joint 25 made of flexible resin between the receiver frames 12a, 12b, as shown in FIG. 13(a). When these receiver frames 12a, 12b are closed, the first frame 12a is arranged to fit into the second frame 12b, as illustrated in FIG. 13(b). At this state, the resin joint 25 is bent and closely attached to the frame 12b. In this embodiment, the sheet 3 is spread over the top surface of the frame 12a, and, on the other hand, the sheet 4, net or transparent plate is disposed over the bottom surface of the frame 12b. According to this structure, when the frame 12a is turned over as indicated by the arrow, the frame 12a fits into the frame 12b, with the sheet 3 now locating on the bottom side. Therefore, the sheet 3 fits tightly on the sheet 4, net or transparent plate, with an organism 34 being sandwiched therebetween. In this condition, the organism 34 can be observed through the transparent sheet 3, transparent sheet 4, net or transparent plate.

Incidentally, the material of the joint 25 should be in no way limited to resins. As far as being flexible and stretchable, any material can be used for the joint 25, including a string or rubber.

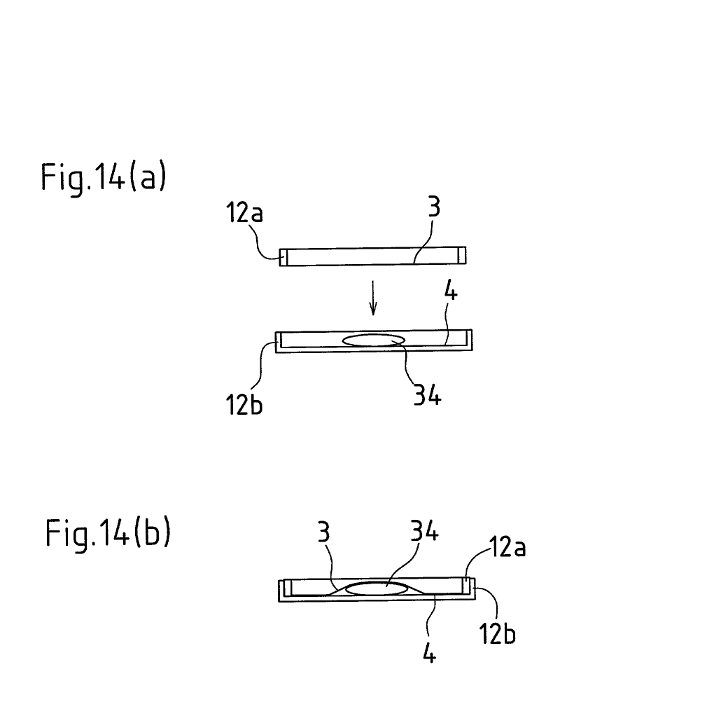

FIG. 14 shows the fifth embodiment.

As for the arrangement illustrated in FIG. 13 where the frames 12a, 12b are hinged together, the fifth embodiment prepares the frame 12a and the frame 12b separately and leaves them unconnected. To use this living organism observation tool, the frame 12a is downwardly fitted into the frame 12b, with the sheet 3 on the frame 12a as well as the sheet 4, net or transparent plate on the frame 12b facing downwards. Hence, the sheet 3 is tightly attached to the sheet 4, net or transparent plate, with an organism 34 being sandwiched therebetween. In this condition, the organism 34 can be observed through the transparent sheet 3, transparent sheet 4, net or transparent plate.

In all of the above embodiments, the frames may be made of any appropriate material other than plastics. In addition, the shape of the frames may be not only square but also in any optional form.

Owing to the above embodiments, an organism (e.g. an insect) can be observed in such a state as sandwiched between the highly stretchable transparent sheets. As a result, a person who is unwilling to touch an insect or the like is no longer bothered by the trouble of holding it in the hand, so that he/she can make an easy observation. Besides, when an observation object is held in the hand, an excessive grip may crush an insect, etc. in the hand, whereas a loose grip may let it escape from the hand. This inconvenience is also solved by the above embodiments. Moreover, conventional observations are often interrupted due to the presence of the hand which holds the observation object. On the other hand, the present embodiments ensure an overall examination without interference. Thus, a lot of advantages are expected when an observation object is not directly held in the hand.

In contrast, reference can be made to some conventional hand-free observation means. An insect cage may be satisfactory in observing the movement of an insect, etc. However, since the insect, etc. is free to move in the cage, it is unsuitable for observation of detailed structures of its body parts. Alternatively, when an insect, etc. is pinned down, a person can observe the pinned side of the object, but cannot see its backside. This method thus fails to offer an overall body image in the natural state. For detailed observation of a little fish, etc., an aquarium is insufficient, partly because the little fish, etc. moves swiftly in the water, and partly because the water obscures the image of the object. If a little fish, etc. is put on paper, precise examination is extremely difficult, because the little fish jumps violently. As for microorganisms like plankton, the observation object is too small to be placed on a preparation without inclusion of other matters. In the case of plants, they can be usually observed in the hand. Nevertheless, it is difficult to observe some plants that cannot stand alone without support, such as wilted plants, water plants and algae. These numerous conventional problems are solved without difficulty by the present embodiments. To be more specific, a pair of highly stretchable transparent sheets sandwich an organism (e.g. an insect) on both sides, with the sheets stretching in accordance with the profile of the insect. As a result, while the observation object is kept stationary or in the state of limited movement (i.e. capable of moving feet, etc. to some degree), the whole body of the object can be examined from every direction in its natural state. Besides, a person can touch the object via the sheets with his/her finger, etc., and feel, for example, the surface profile of the outer shell of an insect.

Incidentally, it is advised to drop a suitable amount of water on the sheet, before the frames are folded together. As the sheets are establishing closer contact, the water spreads adequately to facilitate observation of microorganisms, etc.

When the net is laid over one of the pair of frames, the net is utilized to scoop up a small organism living in the water (e.g. little fish) or microorganisms (e.g. plankton), and the sheet is covered thereon to sandwich the little fish, etc. between the net and the sheet. Thus, while the movement of the little fish, etc. is restricted, a person can make detailed observation through the transparent sheet. In addition, the net portion can be dipped in the water during the observation of an organism. For example, a fish caught in the tool can be observed alive under the natural condition.

Further, by depositing a transparent plate on one of the pair of frames, the resulting tool is particularly useful when one of the holding surfaces should be flat during observation. Use of a transparent plate also contributes to cost reduction.

In the embodiments shown in FIG. 1 to FIG. 12, the receiver frames 12 and the fixture frames 13 for the grip frame 1 and the cover frame 2 can be prepared as common components. Therefore, the living organism observation tool can be produced in a simpler process at a lower cost.

As described above, the living organism observation tool of the present invention ensures easy and detailed observation of small living organisms (e.g. insects, little fish), microorganisms (e.g. plankton) and plants by holding such observation objects in their natural state. This tool is advantageous in that a person can observe and feel the movement of body parts (e.g. feet, antennae, mouth, gills) of an observation object, even if the object is alive.

Taking advantage of its capability for minute observation, the living organism observation tool of the present invention will be beneficial to various fields. To give an example, the tool may be used for preparation of an elaborate lure.

Besides, the living organism observation tool of the present invention can motivate and encourage children to make observations on their own initiative. With the help of this tool, children will get more interested in the living creatures around them.

What is claimed is:

1. A living organism observation tool to be used for observation of a living organism including an insect, a little fish and other small animals or a plant, which comprises:
a pair of frames which can be folded over each other, with each frame being tightly attached to the other along a periphery thereof; and
an elastic transparent sheet which is spread over each of the frames in such a manner as tightly attached along the periphery of each frame,
wherein the frames are folded over each other, with a sheeted surface of each frame facing that of the other frame, so as to attach the sheets tightly to each other, whereby an organism is sandwiched between the sheets and observed in such a state.

2. A living organism observation tool according to claim 1, wherein a net is spread over one of the pair of frames in such a manner as tightly attached along the periphery of the frame.

3. A living organism observation tool according to claim 1, wherein a transparent plate is laid over one of the pair of frames in such a manner as tightly attached along the periphery of the frame.

4. A living organism observation tool to be used for observation of a living organism including an insect, a little fish and other small animals or a plant, which comprises:
a pair of frames, one of which can fit into the other; and
an elastic transparent sheet which is spread over each of the frames in such a manner as tightly attached along a periphery of each frame,
wherein the frames are fitted together, with a sheeted surface of each sheet facing in the same direction, so as to attach the sheets tightly to each other, whereby an organism is sandwiched between the sheets and observed in such a state.

5. A living organism observation tool according to claim 4, wherein a net is spread over one of the pair of frames in such a manner as tightly attached along the periphery of the frame.

6. A living organism observation tool according to claim 4, wherein a transparent plate is laid over one of the pair of frames in such a manner as tightly attached along the periphery of the frame.
